(19) United States
(12) Patent Application Publication
(10) Pub. No.: US 2008/0103917 A1
(43) Pub. Date: May 1, 2008

(54) Service order system and service carrier

(76) Inventor: Coleman Lauderdale, Las Vegas, NV (US)

Correspondence Address: Mark A. Litman & Associates, P.A.;York Business Center, Suite 205, 3209 West 76th St., Edina, MN, 55435, US

(21) Appl. No.: 11/591,210

(22) Filed: Nov. 1, 2006

(51) Int. Cl. G06Q 30/00

(52) U.S. Cl. 705/26; 705/15

(57) ABSTRACT

A portable data entry system, method and carriage system with wireless communication sending capability may have a data entry system, microprocessor and display screen. The data entry system allows a user of the data entry system to provide orders for cocktail service by entering data from a menu. The menu may contain at least:
f) table location;
g) at least three different beverage classes;
h) multiple beverage brands or types for at least one beverage class;
i) standard mixed beverage names or specific lists of combinations of materials with at least one beverage class; and
j) a straight-up or with ice identifier.
   Multiple orders or single orders may be stored in the processor and forwarded as a batch order to a receiver by the wireless communication.

### FIELD OF THE INVENTION

The present invention relates to the field of customer service, food or beverage service for customers, ordering for customers, provision of service systems for ordering from customers and serving customers, and methods of delivering such orders to customers.

### BACKGROUND OF THE ART

There is a constant balance that must be struck in the food and beverage industry between the need for accurate and rapid service, the fact that these demands have large personnel requirements and the need for controlling costs. Numerous systems have been proposed and implemented to address various commercial environments for providing ordering, preparation and servicing needs for commercial use. However well such individual systems may be effective for unique environments, each system is not applicable or effective in all environments.

U.S. Pat. No. 5,003,472 (Perrill) discloses apparatus for order entry in a restaurant includes a host and remote portable terminals. Orders are entered on the remote terminals and sent by radio frequency communication to the host systems. The portable terminals include a bar code template of menu items and a light pen for scanning menu item selections. Orders are entered by scanning selections in a manner similar to the use of a conventional restaurant order pad. Terminals and printers are connected to the host system and are used to display orders entered at portable terminals for the cooks in the kitchen and to print order receipts.

U.S. Pat. No. 4,530,067 (Dorr) discloses a method and apparatus for managing information and the control of restaurants. The apparatus includes a plurality of remote units carried by waiters. The remote units are equipped with a keyboard, a display and a memory source with radio transmission and receiving capability. A central interrogator transceiver periodically interrogates each of the remote units after which the remote units transmit information back to the central interrogator. The central interrogator transceiver couples the information transmitted thereto to a central processor with high speed memory. The processor operates on the information received to provide order information to a kitchen display, an order assembly display, a service bar display, a table status display and to a check printer-cash register. The order information is coupled to an inventory control unit for decrementing the various items in inventory by the quantity of items ordered by each customer. However, this system directly omits the customer within this link of communication.

U.S. Pat. No. 5,699,039 (Korzen) discloses an electronic table pager and display device comprising a menu stand which includes a call activation switch for summoning a server to a table in a restaurant. The device includes a housing having a base that supports a low energy light source therein. When a patron wants to summon a waiter, that patron actuates a simple membrane switch which provides a modulated output signal to the light source via an inverter circuit, so that the light source emits light pulses to attract and summon a waiter to the table. Such systems requires visual eye contact with the illuminated device, which in most instances becomes ineffective because the waiter/waitress is preoccupied or not properly positioned for identifying the visual signal. Also, it has been found that such use of light sources have been improperly installed or do not compensate for the range of heights of the waiter/waitress thereby preventing effective visibility of an illuminated light signal.

U.S. Pat. No. 5,838,798 (Stevens, III) discloses a restaurant transaction processing system which employs low cost cordless phone transceivers to transmit orders. A server having a first cordless telephone transceiver receives data from a portable computer via a second cordless telephone transceiver. The first and second cordless transceivers operate at FCC designated transmission frequencies for a range within less than five thousand feet. A typical frequency of operation is in a frequency band near 900 MHz.

U.S. Pat. No. 6,208,976 (Kinebuchi) describes an order management system enables a customer to use a terminal device to order food, but can respond rapidly to changes and additions to the menu. When this system starts up, it transmits an operating program and image data from main management equipment to each of a number of order-taking terminal devices. Each order-taking terminal device stores the thus received operating program and image data and displays a menu screen on a display screen on the basis of the thus stored operating program and image data.

U.S. Pat. No. 5,839,115 (Coleman) discloses a restaurant management system which monitors inventory sent to a user from a supplier. Each item in the order has an associated minimum time until the order may be delivered. A renumeration system is used to collect money in response to the receipt of an order. An associated alarm with selective thresholds is used to indicate a predetermined duration of time from the receipt of an order to actual delivery. Software features of the system include food, beverage and table selections with payment options on line. However, there is no direct electronic link for communication between the waiter/waitress and customer.

U.S. Pat. No. 5,845,263 (Camaisa et al.) discloses an interactive visual ordering system and method which uses full-color images. The system is used to facilitate menu orders by a customer utilizing a personal computer system with user data input made via a conventional keyboard device. When the customer decides to order a particular menu item, the system captures the ordered items and tabulates a running bill. The pay options include credit and/or debit transactions, but excludes wireless waiter/waitress to customer order resolution. Touch screen activation of orders are made according to this system, and is incorporated herein by reference.

U.S. Pat. No. 5,907,275 (Battistini et al.) discloses an order communication system which allows audiovisual interactive communication between a customer at a remote and fixed order station, and an attendant receiving orders in a restaurant. The order communication system allows display programming in the form of textual and graphical depictions, with two-way live video of both the attendant and customer at fixed stationary points as a fast food drive-thru system.

PCT Publication WO 83/04327 (Pitroda) discloses a restaurant system for processing, controlling and displaying order information received via a one-way signal transmitting terminal located in a remote area. Other conventional features of general relevance to the wireless maitre d' system and method as herein described are those disclosed in the published PCT application (WO 99/48034) by Michot. Michot teaches a method and device for making automatic payments of a selective or group of items. The method consists of assigning to each consumer a transponder module having an identification code representative of an account balance stored therein, and subtracting the price of a picked or selected item thereby providing an updated balance for the consumer at product dispensing points.

Unique designed and operational systems are still required for specialized service environments.

### SUMMARY OF THE INVENTION

A portable data entry system is provided to individual beverage service providers in a casino or wagering environment. Orders can be placed, stored in and sent from the data entry systems by wireless transmission to a receiver that informs a central or satellite beverage providing station of a collective order for a specific service provider. The individual providers return to a beverage providing station, collect a complete order, and return to the casino/wagering environment to deliver the completed order.

The individual data entry systems can be supported on a carrier that also supports multiple trays on which can be carried new beverages to be served and old beverage containers to be returned. All references cited in this application are incorporated herein by reference.

### BRIEF DESCRIPTION OF THE FIGURES

FIG. 1 shows a cartage system for carrying beverage trays and the personal data entry system of FIG. 2.

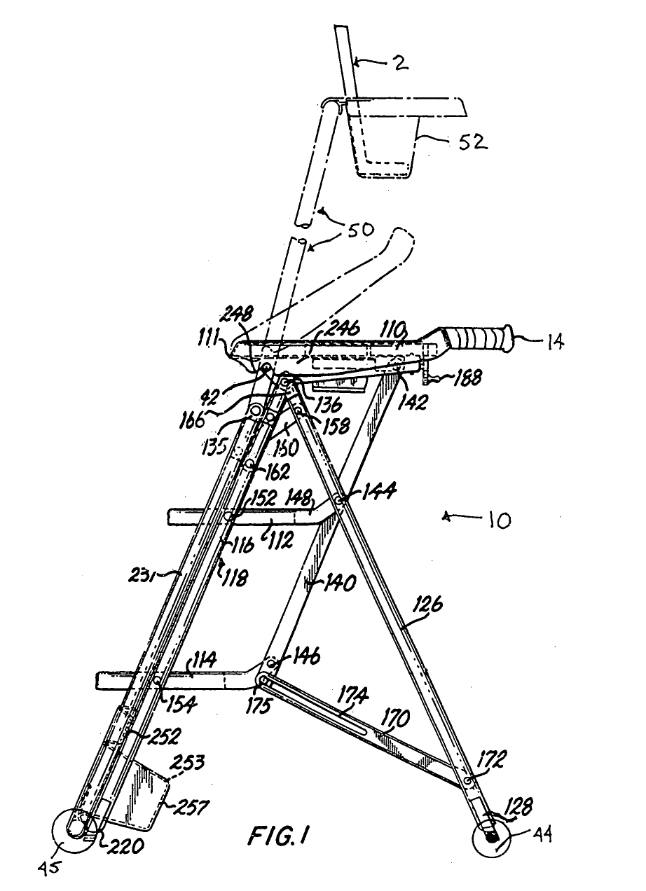

FIG. 2 shows a screen shot on a personal data entry system for beverage service.

### DETAILED DESCRIPTION OF THE INVENTION

In a cocktail beverage service environment, and particularly in a casino wagering environment, the need for fast and accurate beverage delivery using minimal numbers of personnel is a very important aspect of personal interfacing between the casino and the customer. It is annoying to customers when wrong orders are delivered or when an excessive amount of time occurs between orders and delivery. The order and delivery system can be stressful and taxing on waitresses/servers who tend to have to hand write orders, hand deliver orders, wait for orders to be filled, deliver filled orders to the correct locations, and collect empty and used containers. Given the volumes and numbers of deliveries and trips, the likelihood of errors is significant.

The present technology describes a portable data entry system (PDES) provided to individual beverage service providers in a casino or wagering environment. The servers (e.g., cocktail servers or waitresses) can place individual or collective sets of orders on the PDES, including Orders can be placed, stored in and sent from the data entry systems by wireless transmission to a receiver that informs a central or satellite beverage providing station of a collective order for a specific service provider. The individual providers return to a beverage providing station, collect a complete order, and return to the casino/wagering environment to deliver the completed order.

The individual data entry systems can be supported on a carrier that also supports multiple trays on which can be carried new beverages to be served and old beverage containers to be returned. All references cited in this application are incorporated herein by reference.

The cartage system 10 is shown as a collapsible system that may be folded for efficient storage, but it may be a rigid, non-collapsible system. The cartage system 10 shows the use of three carrying tray levels 110 112 114 for carrying beverages, containers, napkins, food and the like. Each tray level 110 112 114 is shown with hinges 142 144 146 so that the cartage system 10 may collapse. The top tray level 110 is shown with handles 14 connected directly to an adjustable, moveable tray 110 with locking elements 188 to assure that the top tray level 110 will move only when desired.

Shown above the top tray level 110 is a data entry device 2 (later described in greater detail) in a support system 52 attached to an extendable telescoping post 50 that is connected through hinges 111 135 into the cartage system 10 through the bottom of the post 248. A lower structural section 246 of the top tray level 110 may provide further stability, resting against other supporting elements such as the resting post 42. Lower structural support for the system is provided by a double forward set of posts 118 having an internal leg 116 and a forward leg 231. There is also provided a rearward leg 126for additional support. Various hinges 135 152 154 163 136 158 144 146 172 assist in the ability of the cartage system to be collapsed. A slip locking system or other locking system 166 may be provided to lock the cartage system 10 so that it cannot collapse during use. The rearward structural support arm 140 is engaged with some of the hinges and the slide opening 174 connected to ping 175 on the lowermost tray level 114 and the rear arm 126 through pivot or hinge 172. A post 128 on the rear arm 126 support a wheel 44 to allow the cartage system 10 to be pushed and rolled. A forward set of wheels 45 is also shown on the forward leg 231, as well as two types of stabilizing or locking mechanisms 253 (which folds down with a flat face 257 against the ground) and extendable post 220 which extends to the ground or into the front wheel 45 to prevent rolling. Although two tray holders are shown it is possible to have one tray, or three or more tray holders.

The server/waitress may place beverages, returns and the like wherever most convenient, and a printed order slip may be provided with the beverages that indicates the original data input to the system, such as the table and position location of players, player's names (to ingratiate the server with the player), a running count of the number or beverages served, and the like to facilitate the work of the server. The top support 52 may be used to carry a printed list as opposed to the data entry system, which may be placed on the upper tray or attached in another position on the support 52 along with printed text.

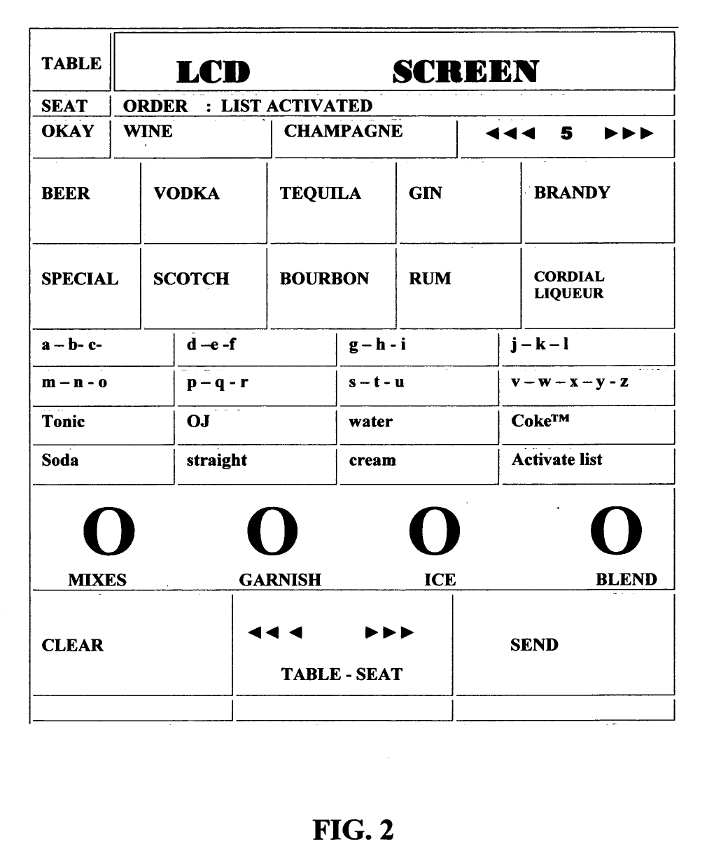

FIG. 2 shows an embodiment of a screen shot of one design of a touchscreen data entry format for practice of the present technology. The server, waitress, cocktail hostess or the like has access to a wireless data transmitter with this type of data entry available. One process for entering data could be performed as follows:
1. The table data entry area is pressed and then the table number is identified by progression arrows 5 with Table 5 being shown in FIG. 2. This table number and other data entered can be viewed on at least a temporary basis (especially until the individual order is completed) on the LCD Screen. When the appropriate individual data has been entered or when another data entry list is accessed, or the Okay area pressed, the entered data content for a particular order is retained.
2. After the table has been entered, the SEAT area may be pressed and the particular seat or player location entered, again using the progression arrows 5. The actual order of the beverage for the particularly located player (by table and location) can then be entered.
3. The generic type of beverage may be entered from the selection (exemplary and not limiting) shown in FIG. 2. For example, Beer may be pressed and a list of available beers may be displayed (including identification as whether bottled or draft), and the progression arrows 5 may be used to progress through the list. Upon completion of the identification, another table position may be entered to complete that customers order or the Okay button pressed to show that order has been completed.
4. More complex entries occur when something such as Vodka or Blend is entered. For example, with Vodka, one might first get a selection of brands (particularly if the Vodka is ordered straight up or on the rocks) which would be entered with the progression arrows 5 and the Okay entry.
5. If blend is pressed, the system may default to a lower grade of Vodka and then a list of blend components may be provided, or specific drink names (e.g., Screwdriver for Vodka or Rusty Nail with Scotch). The server will then enter the beverage name or specific blend components.
6. Certain common orders or ingredients (such as tonic, Orange Juice, water, Coke®, soda, cream and straight may have individual data entry areas, or unique drinks, mixtures, instructions (e.g., shaken not stirred) or additives may be identified with alphanumeric entry through the keyboard type entry shown in FIG. 2.
7. After a specific number or sufficient number (at the election of the server) of orders has been placed, the server can send the collective order to the bar or beverage center for preparation. As in many instances the server is delivering past orders at the designated tables while collecting new orders, by the time the old orders have been placed, returns collected, the new order(s) sent and the server returns to the beverage center, the new order, plus a printout of the order with player location may be ready for the server.
8. As there are potentially numerous beverage centers in the larger casinos for handling different areas of the casino, servers and their orders may be screened or uniquely sent to particular beverage centers to assure matching of the orders and the servers.
   The general technology described herein includes various embodiments that may include one or more of at least a portable data entry system with wireless communication sending capability having:

a data entry system, microprocessor and display screen;

the data entry system allowing a user of the data entry system to provide orders for cocktail service by entering data from a menu having at least:
a) table location;
b) at least three different beverage classes;
c) multiple beverage brands or types for at least one beverage class;
d) standard mixed beverage names or specific lists of combinations of materials with at least one beverage class; and
e) a straight-up or with ice identifier;
   wherein multiple orders may be stored in the processor and forwarded as a batch order to a receiver by the wireless communication. The display screen may display all content from a single customer order before displaying a first component of a second is entered into the processor. Both casino table and casino player location of a player at the casino table can be entered into the portable system using a numerical advancement system through numbers of tables and numbers of player positions or keyboard function. Personal identifiers for individual players can be entered into the microprocessor such that at least a name of a player at a casino table and player position can be entered. The use of a specific icon on a touchscreen display may open up a list of mixed drinks by standard drink names. Specific icon on a touchscreen display may open up a list of available garnishes for a drink. The portable system may have icons on a touchscreen for at least opening of lists for wines, beer and liquor.

A method of servicing a casino environment may involve providing a beverage server with a portable data entry system with wireless communication sending capability having at least:

a data entry system, microprocessor and display screen;

the data entry system allowing a user of the data entry system to provide orders for cocktail service by entering data from a menu comprising at least:
a) table location;
b) at least three different beverage classes;
c) multiple beverage brands or types for at least one beverage class;
d) standard mixed beverage names or specific lists of combinations of materials with at least one beverage class; and
e) a straight-up or with ice identifier;
   wherein multiple orders may be stored in the processor and forwarded as a batch order to a receiver by the wireless communication;

the beverage server:
i) identifying into the portable data entry system an order including:
   a) the identity of each table at which a beverage is to be served, and
   b) a complete description of the beverage to be served at that table,
ii) collecting multiple orders,
iii) forwarding the multiple orders to a beverage providing center,
iv) collecting orders from the beverage providing center; and
iv) delivering orders collected from the beverage providing center.
   The method may be practiced wherein no costs, prices or invoices are associated with the orders to be collected by the servers, as is done in complimentary drinks at casinos. The beverage providing center preferably prepares a printed copy of a total order sent by the server and delivers the printed copy with the order. The printed order preferably includes both table identifier and player position identifier at the table. The order may be prepared and provided on a tray for complete delivery to the server.
   The method and device may be used on a cartage system for delivery of consumables by a server comprising a structural support on wheels for movement of the cartage system by a consumable server, at least two support areas on the cartage support system for the carrying of trays of consumables, and a distinct area for carriage of a wireless portable data entry device. The cartage system may have the portable wireless data entry device removably attached to the cartage system, as by a clip, fitted slip-in case, Velcro® attachment, pressure-sensitive adhesive, snaps and the like.

The technology herein described may preferably use wireless communication systems with either short range or long range signal capability. The hand-held or carried data entry systems may have individual programs within each device or may operate on a thin-client relationship from a central processor-server such as a computer, processor-server located within the casino or at the beverage dispensary. This system provides a benefit for the casino by potentially reducing the number of staff needed for the cocktail function, increasing the accuracy of the orders, adding potential for better interpersonal relations between customer and server, and providing the customers with a higher level of satisfaction in the promptness and accuracy of their service. Other variations, alternatives and equivalents would be easily appreciated by those skilled in the art as within the general teachings provided herein.

What is claimed:

1. A portable data entry system with wireless communication sending capability comprising:
a data entry system, microprocessor and display screen;
the data entry system allowing a user of the data entry system to provide orders for cocktail service by entering data from a menu comprising at least:
a) table location;
b) at least three different beverage classes;
c) multiple beverage brands or types for at least one beverage class;
d) standard mixed beverage names or specific lists of combinations of materials with at least one beverage class; and
e) a straight-up or with ice identifier;
wherein multiple orders may be stored in the processor and forwarded as a batch order to a receiver by the wireless communication.

2. The portable system of claim 1 wherein the display screen displays all content from a single customer order before displaying a first component of a second is entered into the processor.

3. The portable system of claim 1 wherein both casino table and casino player location of a player at the casino table can be entered into the portable system using a numerical advancement system through numbers of tables and numbers of player positions.

4. The portable system of claim 3 wherein personal identifiers for individual players can be entered into the microprocessor such that at least a name of a player at a casino table and player position can be entered.

5. The portable system of claim 1 wherein a specific icon on a touchscreen display opens up a list of mixed drinks by standard drink names.

6. The portable system of claim 1 wherein a specific icon on a touchscreen display opens up a list of available garnishes for a drink.

7. The portable system of claim 1 having icons on a touchscreen for at least opening of lists for wines, beer and liquor.

8. A method of servicing a casino environment comprising providing a beverage server with a portable data entry system with wireless communication sending capability comprising:
a data entry system, microprocessor and display screen;
the data entry system allowing a user of the data entry system to provide orders for cocktail service by entering data from a menu comprising at least:
a) table location;
b) at least three different beverage classes;
c) multiple beverage brands or types for at least one beverage class;
d) standard mixed beverage names or specific lists of combinations of materials with at least one beverage class; and
e) a straight-up or with ice identifier;
wherein multiple orders may be stored in the processor and forwarded as a batch order to a receiver by the wireless communication;
the beverage server:
i) identifying into the portable data entry system an order including:
a) the identity of each table at which a beverage is to be served, and
b) a complete description of the beverage to be served at that table,
ii) collecting multiple orders,
iii) forwarding the multiple orders to a beverage providing center,
iv) collecting orders from the beverage providing center; and
iv) delivering orders collected from the beverage providing center.

9. The method of claim 8 wherein no costs, prices or invoices are associated with the orders to be collected by the servers.

10. The method of claim 8 wherein the beverage providing center prepares a printed copy of a total order sent by the server.

11. The method of claim 10 wherein the server receives the printed order along with the order.

12. The method of claim 12 wherein the printed order includes both table identifier and player position identifier at the table.

13. The method of claim 8 wherein the order is prepared and provided on a tray for delivery to the server.

14. A cartage system for delivery of consumables by a server comprising a structural support on wheels for movement of the cartage system by a consumable server, at least two support areas on the cartage support system for the carrying of trays of consumables, and a distinct area for carriage of a wireless portable data entry device.

15. The cartage system of claim 14 wherein the wireless portable data entry device comprises
a data entry system, microprocessor and display screen;
the data entry system allowing a user of the data entry system to provide orders for cocktail service by entering data from a menu comprising at least:
a) table location;
b) at least three different beverage classes;
c) multiple beverage brands or types for at least one beverage class;
d) standard mixed beverage names or specific lists of combinations of materials with at least one beverage class; and
e) a straight-up or with ice identifier;
wherein multiple orders may be stored in the processor and forwarded as a batch order to a receiver by the wireless communication.

16. The cartage system of claim 15 having the portable wireless data entry device removably attached to the cartage system.

17. The cartage system of claim 16 wherein the portable wireless data entry system enables both casino table and casino player location of a player at the casino table to be entered into the portable system using:
a) a numerical advancement system through numbers of tables and numbers of player positions; or
b) key pad entry of table numbers and player locations.

18. The portable cartage system of claim 17 wherein personal identifiers for individual players can be entered into the microprocessor such that at least a name of a player at a casino table and player position can be entered.

19. The portable cartage system of claim 16 wherein a specific icon on a touchscreen display opens up a list of mixed drinks by standard drink names.
